(19) United States
(12) Patent Application Publication
(10) Pub. No.: US 2014/0176483 A1
(43) Pub. Date: Jun. 26, 2014

(54) DRIVING METHOD OF TOUCH PANEL

(71) Applicant: AU OPTRONICS CORP., Hsin-Chu (TW)

(72) Inventor: Ching-Min Lee, Hsin-Chu (TW)

(73) Assignee: AU OPTRONICS CORP., Hsin-Chu (TW)

(21) Appl. No.: 13/771,032

(22) Filed: Feb. 19, 2013

(30) Foreign Application Priority Data
Dec. 20, 2012 (TW) 101148654

(51) Int. Cl. G06F 3/044

(52) U.S. Cl. CPC G06F 3/044
USPC 345/174

(57) ABSTRACT

A driving method of a touch panel includes providing a touch panel including a plurality of first sensing electrodes arranged along a first direction and a plurality of second sensing electrodes arranged along a second direction different from the first direction; simultaneously outputting driving signals through the plurality of first sensing electrodes for generating a first set of sensing signals on the plurality of second sensing electrodes; simultaneously outputting driving signals through the plurality of second sensing electrodes for generating a second set of sensing signals on the plurality of first sensing electrodes; determining whether the touch panel is touched according to the first set of sensing signals and the second set of sensing signals; and when determining the touch panel is touched, sequentially outputting driving signals through the plurality of first sensing electrodes for generating a third set of sensing signals on the plurality of second sensing electrodes.

### BACKGROUND OF THE INVENTION

1. Field of the Invention

The present invention relates to a driving method of a touch panel, and more particularly, to a driving method of a touch panel capable of improving sensing efficiency.

2. Description of the Prior Art

Please refer to FIG. 1 and FIG. 2 together. FIG. 1 is a diagram showing a touch panel 100 of the prior art. FIG. 2 is a diagram illustrating a driving method of the touch panel 100 of the prior art. As shown in the figures, the touch panel 100 of the prior art comprises a plurality of first sensing electrodes Y1-Ym arranged along a first direction A, a plurality of second sensing electrodes X1-Xn arranged along a second direction B different from the first direction A, and a touch control unit 110 coupled to the plurality of first sensing electrodes Y1-Ym and the plurality of second sensing electrodes X1-Xn. The touch control unit 110 is for sequentially outputting driving signals TX through the first sensing electrodes Y1-Ym to generate sensing signals RX on the second sensing electrodes X1-Xn. The touch control unit 110 can determine whether the touch panel 100 is touched and determine touched positions of the touch panel 100 according to received sensing signals RX after completely scanning the whole touch panel 100.

However, according to the above driving method, it takes one scanning period m×T to completely scan the whole touch panel 100. If one specific point is touched after the scanning, the touch control unit 110 is not able to determine the touch panel 100 is touched until next scanning period is finished. For example, if point P is touched after the first sensing electrode Y1 is scanned, the touch control unit 110 must wait till the next scanning period is finished to determine the touch panel is touched, that is, it takes the touch control unit 110 a length of time (m−1)×T+m×T to determine the touch panel 100 is touched. Therefore, the driving method of the touch panel 100 of the prior art is not capable of quickly and efficiently determining whether the touch panel 100 is touch.

### SUMMARY OF THE INVENTION

The present invention provides a driving method of a touch panel. The driving method comprises providing a touch panel comprising a plurality of first sensing electrodes arranged along a first direction and a plurality of second sensing electrodes arranged along a second direction different from the first direction; simultaneously outputting driving signals through the plurality of first sensing electrodes for generating a first set of sensing signals on the plurality of second sensing electrodes; simultaneously outputting driving signals through the plurality of second sensing electrodes for generating a second set of sensing signals on the plurality of first sensing electrodes; determining whether the touch panel is touched according to the first set of sensing signals and the second set of sensing signals; and when determining the touch panel is touched, sequentially outputting driving signals through the plurality of first sensing electrodes for generating a third set of sensing signals on the plurality of second sensing electrodes.

The present invention further provides a touch panel. The touch panel comprises a plurality of first sensing electrodes arranged along a first direction, a plurality of second sensing electrodes arranged along a second direction different from the first direction, and a touch control unit coupled to the plurality of first sensing electrodes and the plurality of second sensing electrodes. The touch control unit is for simultaneously outputting driving signals through the plurality of first sensing electrodes for generating a first set of sensing signals on the plurality of second sensing electrodes, simultaneously outputting driving signals through the plurality of second sensing electrodes for generating a second set of sensing signals on the plurality of first sensing electrodes, determining whether the touch panel is touched according to the first set of sensing signals and the second set of sensing signals, and when determining the touch panel is touched, sequentially outputting driving signals through the plurality of first sensing electrodes for generating a third set of sensing signals on the plurality of second sensing electrodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a touch panel of the prior art.

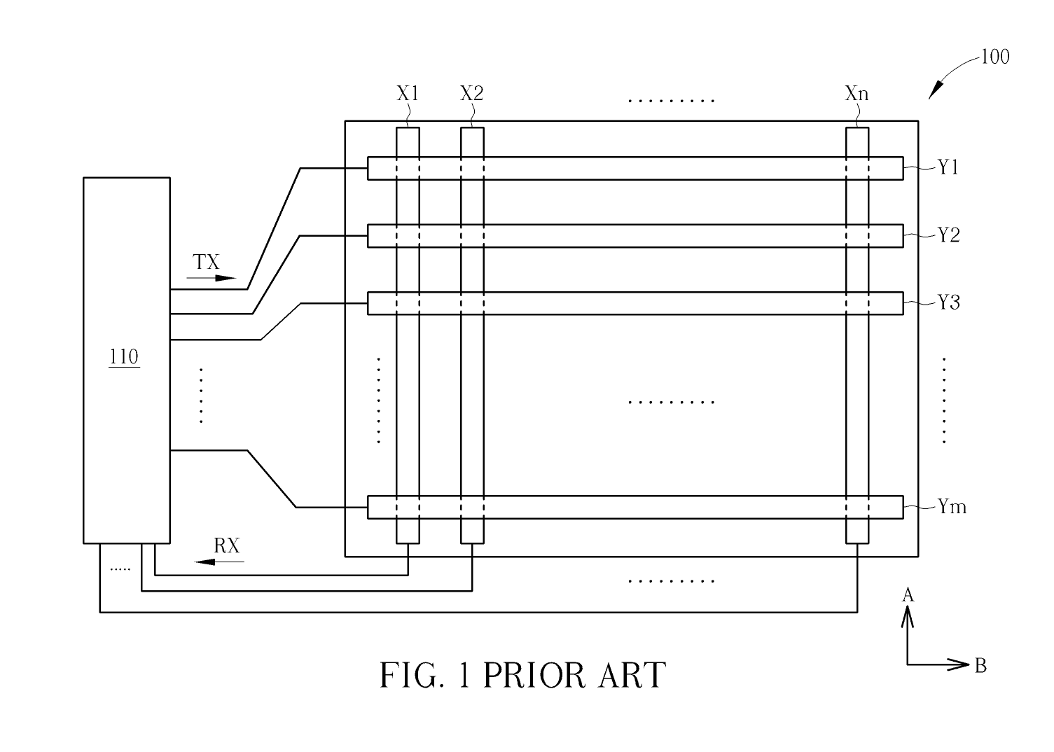

FIG. 2 is a diagram illustrating a driving method of the touch panel of the prior art.

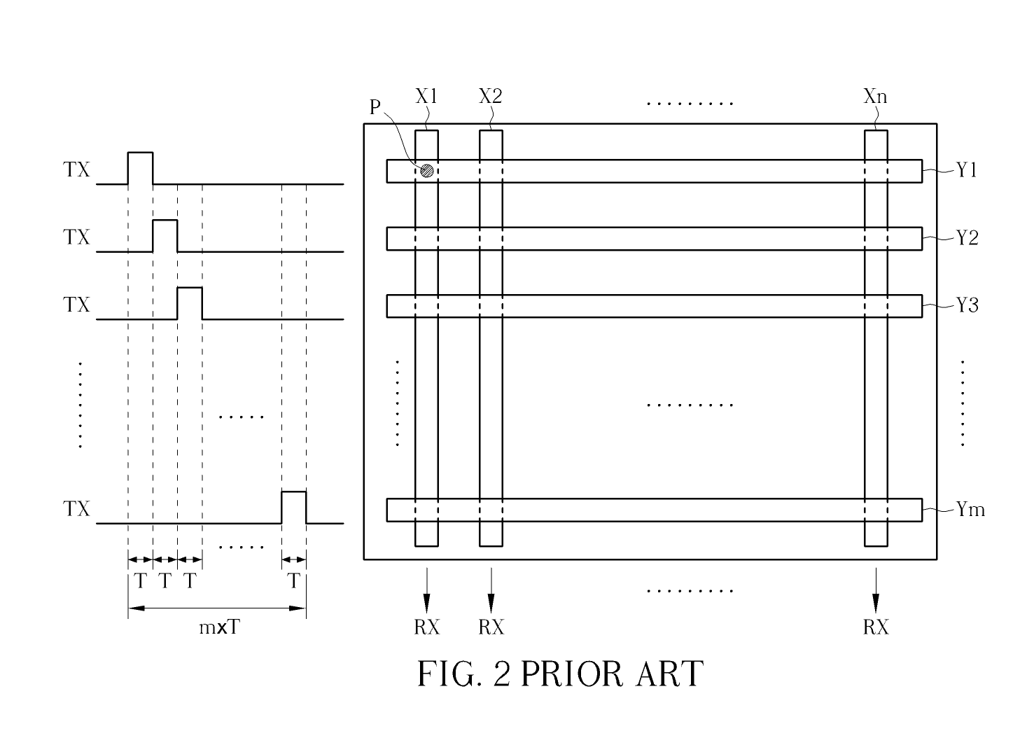

FIG. 3 is a diagram showing a touch panel of the present invention.

FIG. 4 is a diagram showing the touch control unit driving the touch panel according to the first driving mode.

FIG. 5 is a diagram showing the touch control unit driving the touch panel according to the first driving mode.

FIG. 6 is a diagram showing the touch control unit driving the touch panel according to the second driving mode.

FIG. 7 is a flowchart showing the driving method of the touch panel of the present invention.

### DETAILED DESCRIPTION

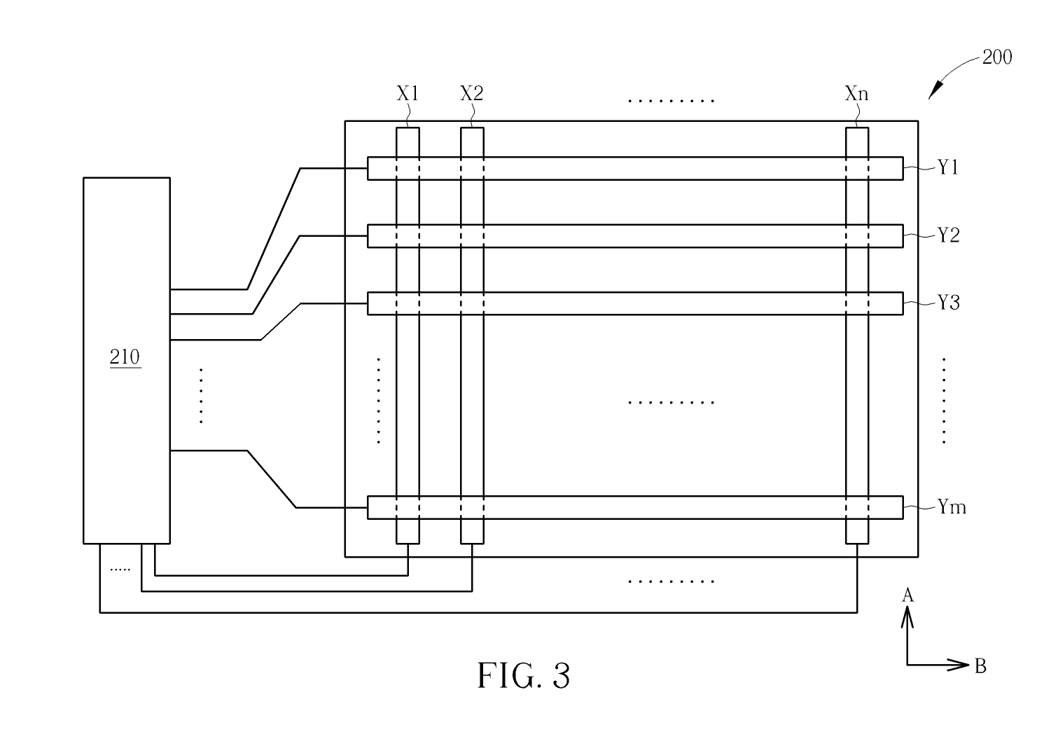

Please refer to FIG. 3. FIG. 3 is a diagram showing a touch panel of the present invention. The touch panel 200 of the present invention can be a capacitive touch panel. As shown in FIG. 3, the touch panel 200 of the present invention comprises a plurality of first sensing electrodes Y1-Ym arranged along a first direction A, a plurality of second sensing electrodes X1-Xn arranged along a second direction B different from the first direction A, and a touch control unit 210 coupled to the plurality of first sensing electrodes Y1-Ym and the plurality of second sensing electrodes X1-Xn. Different from the prior art, when the touch control unit 210 determines the touch panel 200 is in an untouched status, the touch control unit 210 drives the touch panel 200 according to a first driving mode, and when the touch control unit 210 determines the touch panel 200 is in a touched status, the touch control unit 210 drives the touch panel 200 according to a second driving mode.

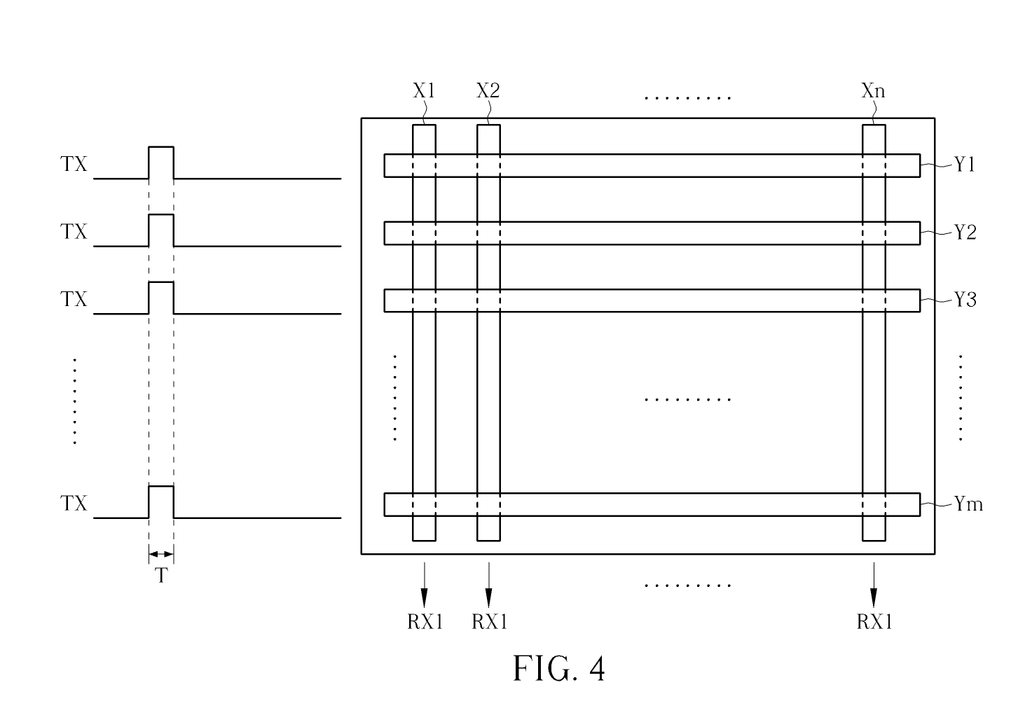

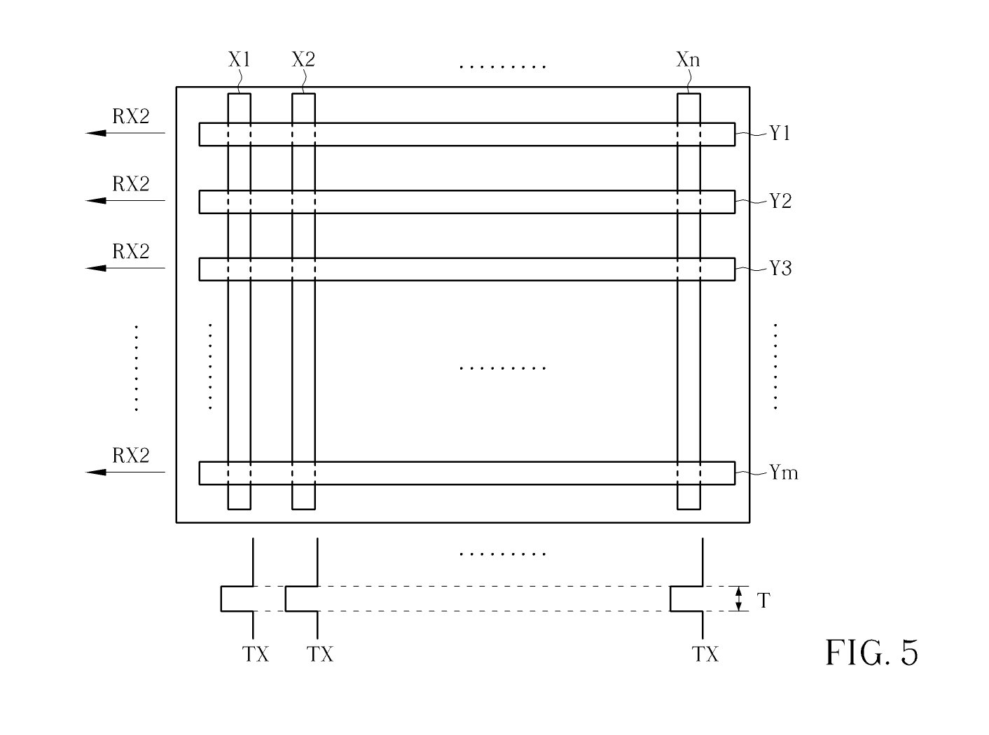

For example, please refer to FIG. 4 and FIG. 5 together, and refer to FIG. 3 as well. FIG. 4 and FIG. 5 are diagrams showing the touch control unit driving the touch panel according to the first driving mode. As shown in figures, when the touch control unit 210 determines the touch panel 200 is in the untouched status, the touch control unit 210 simultaneously outputs driving signals TX through all of the first sensing electrodes Y1-Ym for generating a first set of sensing signals RX1 on the plurality of second sensing electrodes X1-Xn, thereafter, the touch control unit 210 simultaneously outputs driving signals TX through all of the second sensing electrodes X1-Xn for generating a first set of sensing signals RX1 on the plurality of first sensing electrodes Y1-Ym. When the touch panel stays in the untouched status, the touch control unit 210 continues to drive the touch panel 200 according to the first driving mode.

According to the above arrangement, the touch control unit 210 interlacedly outputs driving signals TX through all of the first sensing electrodes Y1-Ym and all of the second sensing electrodes X1-Xn, such that it only takes the touch control unit 210 a length of time 2×T to determine whether the touch panel 200 is touched and determine a touched position of the touch panel 200. In the first driving mode, the touch control unit 210 performs single-touch operation.

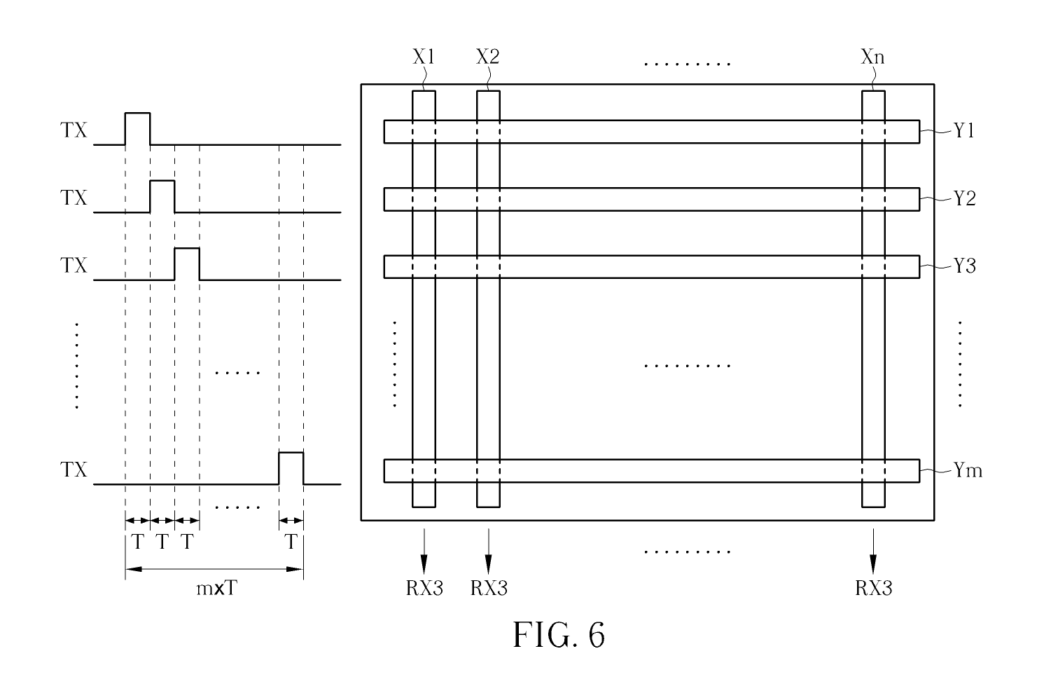

Please refer to FIG. 6, and refer to FIG. 3 as well. FIG. 6 is a diagram showing the touch control unit 210 driving the touch panel 200 according to the second driving mode. As shown in FIG. 6, when the touch control unit 210 determines the touch panel 200 is in the touched status, the touch control unit 210 sequentially outputs driving signals TX through the plurality of first sensing electrodes Y1-Ym for generating a third set of sensing signals RX3 on the plurality of second sensing electrodes X1-Xn (or outputs driving signals TX through the plurality of second sensing electrodes X1-Xn for generating the third set of sensing signals RX3 on the plurality of first sensing electrodes Y1-Ym), the touch control unit 210 then determines whether the touch panel 200 is touched and determines a touched position (or a plurality of touched positions) according to the third set of sensing signals RX3.

According to the above arrangement, when the touch control unit 210 determines the touch panel 200 is in the touched status, the touch control unit 210 switches to the second driving mode to drive the touch panel 200. In the second driving mode, the touch control unit 210 sequentially outputs driving signals TX through the plurality of first sensing electrodes Y1-Ym, such that the touch control unit 210 is capable of performing multi-touch operation for determining multiple touched positions of the touch panel according to the third set of sensing signals RX3.

In addition, when the touch control unit 210 determines the touch panel 200 is not touched (the touch panel 200 is in the untouched status) according to the third set of sensing signals RX3, the touch control unit 210 drives the touch panel 200 according to the first driving mode again.

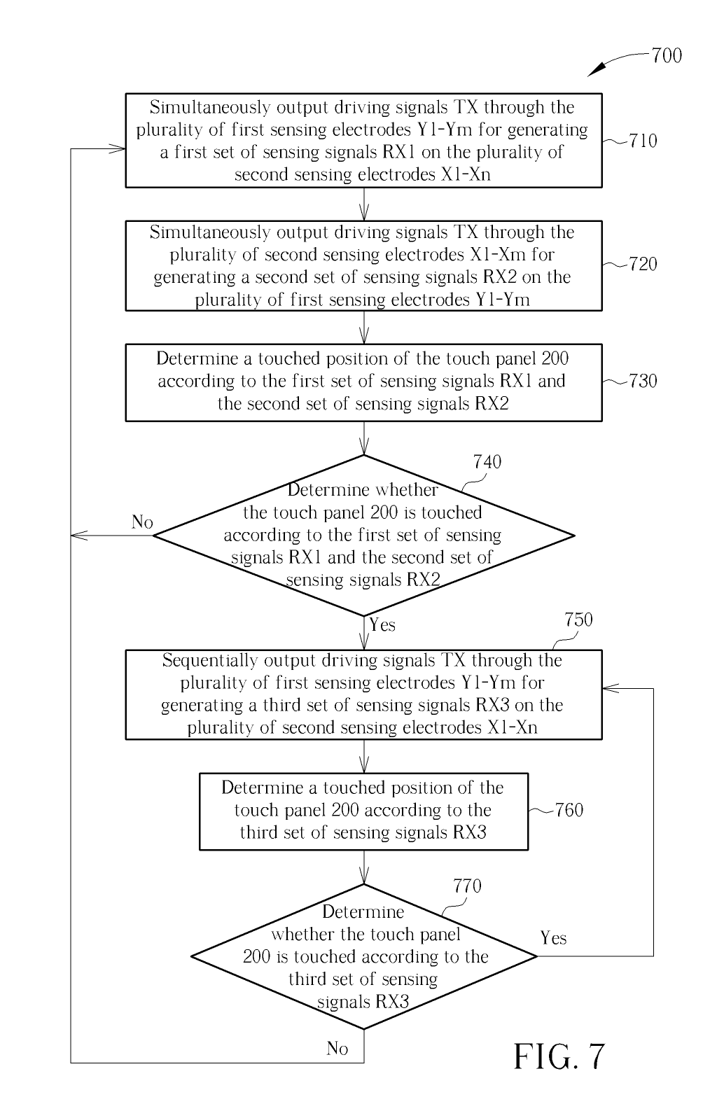

Please refer to FIG. 7. FIG. 7 is a flowchart 700 showing the driving method of the touch panel of the present invention. The flowchart of driving method of the touch panel of the present invention comprises the following steps:

Step 710: Simultaneously output driving signals TX through the plurality of first sensing electrodes Y1-Ym for generating a first set of sensing signals RX1 on the plurality of second sensing electrodes X1-Xn;

Step 720: Simultaneously output driving signals TX through the plurality of second sensing electrodes X1-Xm for generating a second set of sensing signals RX2 on the plurality of first sensing electrodes Y1-Ym;

Step 730: Determine a touched position of the touch panel 200 according to the first set of sensing signals RX1 and the second set of sensing signals RX2;

Step 740: Determine whether the touch panel 200 is touched according to the first set of sensing signals RX1 and the second set of sensing signals RX2; if yes, go to step 750; if not, go to step 710;

Step 750: Sequentially output driving signals TX through the plurality of first sensing electrodes Y1-Ym for generating a third set of sensing signals RX3 on the plurality of second sensing electrodes X1-Xn;

Step 760: Determine a touched position of the touch panel 200 according to the third set of sensing signals RX3; and

Step 770: Determine whether the touch panel 200 is touched according to the third set of sensing signals RX3; if yes, go to step 750; if not, go to step 710.

In contrast to the prior art, the driving method of the touch panel of the present invention can quickly and efficiently determine whether the touch panel is touched according to the first driving mode when the touch panel is in the untouched status, and perform multi-touch operation according to the second driving mode when the touch panel is in the touched status. Therefore, the driving method of the touch panel of the present invention can improve sensing efficiency of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method of a touch panel, comprising:
providing a touch panel comprising a plurality of first sensing electrodes arranged along a first direction and a plurality of second sensing electrodes arranged along a second direction different from the first direction;
simultaneously outputting driving signals through the plurality of first sensing electrodes for generating a first set of sensing signals on the plurality of second sensing electrodes;
simultaneously outputting driving signals through the plurality of second sensing electrodes for generating a second set of sensing signals on the plurality of first sensing electrodes;
determining whether the touch panel is touched according to the first set of sensing signals and the second set of sensing signals; and
when determining the touch panel is touched, sequentially outputting driving signals through the plurality of first sensing electrodes for generating a third set of sensing signals on the plurality of second sensing electrodes.

2. The driving method of claim 1 further comprising:
determining a touched position of the touch panel according to the first set of sensing signals and the second set of sensing signals.

3. The driving method of claim 1 further comprising:
determining a touched position of the touch panel according to the third set of sensing signals.

4. The driving method of claim 3, wherein determining the touched position of the touch panel according to the third set of sensing signals comprises determining a plurality of touched positions of the touch panel according to the third set of sensing signals.

5. The driving method of claim 1 further comprising:
determining whether the touch panel is touched according to the third set of sensing signals; and
when determining the touch panel is not touched according to the third set of sensing signals, simultaneously outputting driving signals through the plurality of first sensing electrodes.

6. A touch panel, comprising:
a plurality of first sensing electrodes arranged along a first direction;
a plurality of second sensing electrodes arranged along a second direction different from the first direction; and
a touch control unit coupled to the plurality of first sensing electrodes and the plurality of second sensing electrodes, for simultaneously outputting driving signals through the plurality of first sensing electrodes for generating a first set of sensing signals on the plurality of second sensing electrodes, simultaneously outputting driving signals through the plurality of second sensing electrodes for generating a second set of sensing signals on the plurality of first sensing electrodes, determining whether the touch panel is touched according to the first set of sensing signals and the second set of sensing signals, and when determining the touch panel is touched, sequentially outputting driving signals through the plurality of first sensing electrodes for generating a third set of sensing signals on the plurality of second sensing electrodes.

7. The touch panel of claim 6, wherein the touch control unit is further configured to determine a touched position of the touch panel according to the first set of sensing signals and the second set of sensing signals.

8. The touch panel of claim 6, wherein the touch control unit is further configured to determine a touched position of the touch panel according to the third set of sensing signals.

9. The touch panel of claim 6, wherein the touch control unit is further configured to determine whether the touch panel is touched according to the third set of sensing signals, and simultaneously output driving signals through the plurality of first sensing electrodes when determining the touch panel is not touched according to the third set of sensing signals.

10. The touch panel of claim 6 being a capacitive touch panel.
